(19) United States
(12) Patent Application Publication
(10) Pub. No.: US 2024/0351522 A1
(43) Pub. Date: Oct. 24, 2024

(54) ELECTRO-OPTIC MIRROR REFLECTIVE ELEMENT SUB-ASSEMBLY FOR VEHICULAR REARVIEW MIRROR ASSEMBLY

(71) Applicant: Magna Mirrors of America, Inc., Holland, MI (US)

(72) Inventors: Michael J. Baur, Kentwood, MI (US); Rex E. Blakeman, Michigan Center, MI (US)

(21) Appl. No.: 18/638,936

(22) Filed: Apr. 18, 2024

Related U.S. Application Data
(60) Provisional application No. 63/497,457, filed on Apr. 21, 2023.

(51) Int. Cl. B60R 1/08; B60R 1/04

(52) U.S. Cl. CPC B60R 1/088; B60R 1/04

(57) ABSTRACT

An electrochromic mirror reflective element sub-assembly for a vehicular rearview mirror assembly includes a front substrate having first and second surfaces with a transparent electrically conductive coating at the second surface, and a rear substrate having third and fourth surfaces, with an electrically conductive coating disposed at the third surface. A perimeter sealing element is disposed between the second and third surfaces and bounding an interpane cavity between the front and rear substrates. The perimeter sealing element includes an adhesive strip adhered to respective perimeter regions of the second and third surfaces. The perimeter sealing element includes a first electrically conductive trace for electrically connecting to the transparent electrically conductive coating and a second electrically conductive trace for electrically connecting to the electrically conductive coating. An electrochromic medium is disposed within the interpane cavity and contacts the transparent electrically conductive coating and the electrically conductive coating.

### CROSS REFERENCE TO RELATED APPLICATION

The present application claims the filing benefits of U.S. provisional application Ser. No. 63/497,457, filed Apr. 21, 2023, which is hereby incorporated herein by reference in its entirety.

### FIELD OF THE INVENTION

The present invention relates generally to the field of rearview mirror assemblies for vehicles.

### BACKGROUND OF THE INVENTION

It is known to provide a mirror assembly that is mounted at an interior or exterior portion of a vehicle. Such mirror assemblies may include a variably reflectant electrochromic mirror reflective element.

### SUMMARY OF THE INVENTION

An electro-optic mirror reflective element sub-assembly for a vehicular interior or exterior rearview mirror assembly includes a front glass substrate and a rear glass substrate with an electro-optic medium (e.g., an electrochromic medium) disposed between the front and rear glass substrates. The electro-optic mirror reflective element sub-assembly includes a tape-based sealing element or adhesive strip that spans the gap between the front and rear glass substrates and circumscribes and seals the electrochromic medium within the interpane cavity between the front and rear glass substrates. The tape-based sealing element may include electrification traces layered within or integrated in the tape and in electrical contact with the electrically conductive traces that are disposed at the opposing surfaces of the front and rear glass substrates and that contact the electro-optic medium.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly;

FIG. 2 is a sectional view of the mirror reflective element of the mirror assembly of FIG. 1; and

FIG. 3 is an exploded perspective view of the mirror reflective element.

### DESCRIPTION OF THE PREFERRED EMBODIMENTS

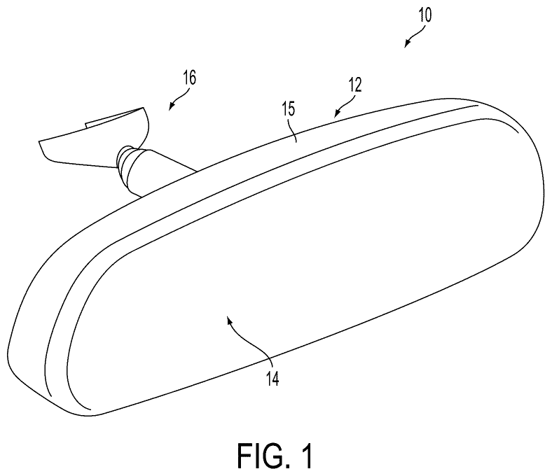

Referring now to the drawings and the illustrative embodiments depicted therein, an interior rearview mirror assembly 10 for a vehicle includes a mirror head 12 that accommodates a mirror reflective element 14 positioned at a front portion of a mirror casing 15 (FIG. 1). In the illustrated embodiment, the mirror assembly 10 is configured to be adjustably mounted to an interior portion of the vehicle (such as to an interior or in-cabin surface of a vehicle windshield or a headliner of a vehicle or the like) via a mounting structure or mounting configuration or assembly 16. The mirror reflective element comprises a variable reflectance mirror reflective element that varies its reflectance responsive to electrical current applied to conductive coatings or layers of the reflective element.

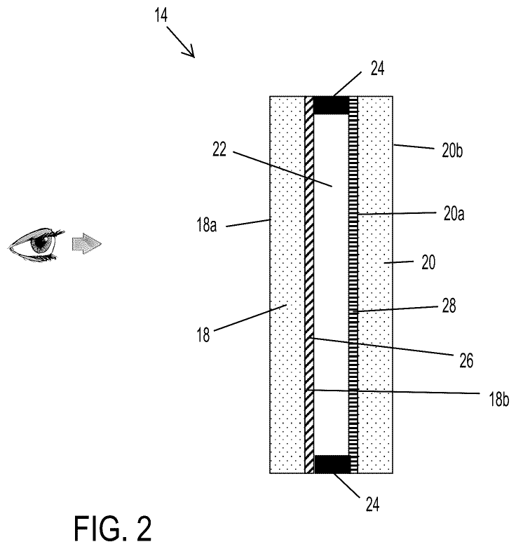

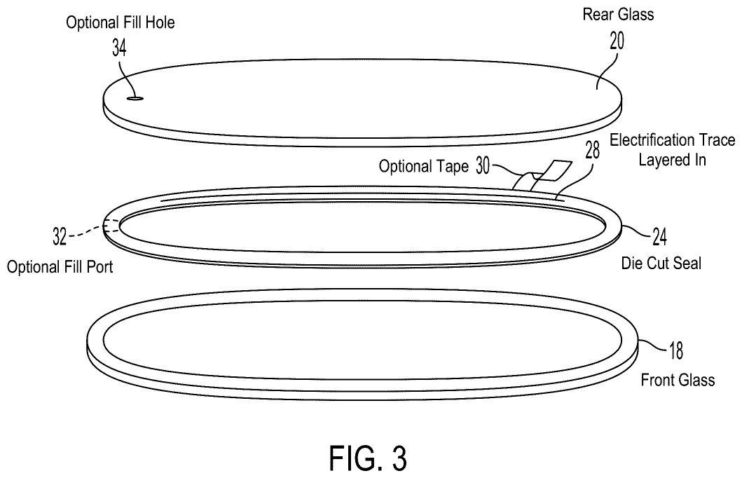

In the illustrated embodiment, and as shown in FIGS. 2 and 3, the mirror reflective element 14 comprises a laminate construction variable reflectance electro-optic (such as electrochromic) reflective element assembly having a front glass substrate 18 and a rear glass substrate 20 with an electro-optic medium 22 (such as electrochromic medium) sandwiched therebetween and bounded by a perimeter sealing element 24. As shown in FIG. 2, the front glass substrate 18 has a front or first surface 18a (the surface that generally faces the driver of a vehicle when the mirror assembly is normally mounted at the vehicle) and a rear or second surface 18b opposite the front surface 18a, and the rear glass substrate 20 has a front or third surface 20a and a rear or fourth surface 20b opposite the front surface 20a, with the electro-optic medium 22 disposed between the second surface 18b and the third surface 20a and bounded by the perimeter sealing element 24 of the reflective element. The second surface 18a of the front glass substrate 18 has a transparent conductive coating 26 established thereat (such as an indium tin oxide (ITO) layer, or a doped tin oxide layer or any other transparent electrically semi-conductive layer or coating or the like (such as indium cerium oxide (ICO), indium tungsten oxide (IWO), or indium oxide (IO) layers or the like or a zinc oxide layer or coating, or a zinc oxide coating or the like doped with aluminum or other metallic materials, such as silver or gold or the like, or other oxides doped with a suitable metallic material or the like, or such as disclosed in U.S. Pat. No. 7,274,501, which is hereby incorporated herein by reference in its entirety), while the third surface 20a has a metallic reflector coating 28 (or multiple layers or coatings) established thereat. The front or third surface 20a of the rear glass substrate 20 may include one or more transparent semi-conductive layers (such as an ITO layer or the like), and one or more metallic electrically conductive layers (such as a layer of silver, aluminum, chromium or the like or an alloy thereof), and may include multiple layers such as disclosed in U.S. Pat. Nos. 7,274,501; 7,184,190 and/or 7,255,451, which are hereby incorporated herein by reference in their entireties. The mirror reflector may comprise any suitable coatings or layers, such as a transflective coating or layer, such as described in U.S. Pat. Nos. 7,626,749; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are hereby incorporated herein by reference in their entireties, disposed at the front surface of the rear substrate (commonly referred to as the third surface of the reflective element) and opposing the electro-optic medium, such as an electrochromic medium disposed between the front and rear substrates and bounded by the perimeter seal (but optionally, the mirror reflector could be disposed at the rear surface of the rear substrate (commonly referred to as the fourth surface of the reflective element).

The third surface 20a defines the active EC area or surface of the rear substrate within the perimeter sealing 24. The coated third surface 20a may also be coated to define a tab-out region (such as by utilizing aspects of the mirror assemblies described in U.S. Pat. Nos. 7,274,501; 7,184,190 and/or 7,255,451, which are hereby incorporated herein by reference in their entireties) for providing electrical connection of the conductive layers to an electrical clip of connector or bus-bar, such as the types described in U.S. Pat. Nos. 5,066,112 and 6,449,082, which are hereby incorporated herein by reference in their entireties.

The mirror assembly may comprise a frameless mirror assembly, where the front glass substrate may have an exposed rounded perimeter glass edge that provides a curved transition from the planar first surface of the front glass substrate to an outer less curved surface of the mirror casing (such as by utilizing aspects of the mirror assemblies described in U.S. Pat. Nos. 9,827,913; 9,174,578; 8,508,831; 8,730,553; 9,598,016 and/or 9,346,403, which are hereby incorporated herein by reference in their entireties). Optionally, the mirror assembly may include a casing portion that circumscribes the perimeter glass edge of the front glass substrate and provides the curved transition from the planar first surface of the front glass substrate to an outer less curved surface of the mirror casing, with the mirror casing portion not encroaching onto or overlapping the planar front or first surface of the front glass substrate (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties).

Frameless mirrors may use an offset between the front or first substrate and the rear or second substrate to achieve mounting and electrification. That is, the front substrate is overlaid at the rear substrate so that a perimeter edge region or overhang region of the front substrate extends beyond an outer peripheral edge of the rear substrate (in some applications, no part of the rear glass substrate extends to or beyond any peripheral part of the front glass substrate, such that the edges of the front glass substrate extend beyond the edges of the front glass substrate). Optionally, the front substrate and the rear substrate may be substantially equally sized such that the perimeter edges of the respective substrates are substantially aligned and flush with one another along the outer peripheral edge of the mirror reflective element.

Electrical connectors (e.g., electrically conductive coatings or layers and/or electrically conductive epoxy material or the like) extend along the peripheral edges of the rear substrate toward the second surface of the front substrate to electrically connect a power source to the conductive layers at the third surface of the rear substrate and/or the second surface of the front substrate. The mirror reflective element attaches at the mirror casing via any suitable means, such as, for example, via snap attachment of a mirror backing plate (that is adhered at the fourth surface of the rear glass substrate) to the mirror casing, or optionally via an adhesive disposed between the second surface of the front substrate and a surface of the mirror casing and/or an adhesive disposed between the fourth surface of the rear substrate and a surface of the mirror casing. A chrome or reflective band may be deposited on the second surface of the front substrate to conceal the portion of the housing, the perimeter seal, and the electrical connectors that extend along the peripheral edge of the rear substrate.

The sealing element 24 comprises a tape or adhesive strip that is cut or formed (e.g., such as laser cut or die cut) to fit the particular shape of the mirror reflective element. In other words, with the tape disposed between the third surface 20a of the rear substrate 20 and the second surface 18b of the front substrate 18, an outer perimeter edge of the tape may substantially align with a perimeter edge of one or both of the front substrate 18 and the rear substrate 20. The tape-based sealing element may be augmented with electrification traces 28 to make effective electrical contact with the anodic and cathodic surfaces of the glass substrates. These traces may be electrically connected to other electrification components, such as flexible printed circuits or FPCs 30, metal tabs, etc. The traces 28 may be electrically connected to the electrical connectors at the fourth surface 20b of the mirror reflective element for electrically connecting the electrochromic medium to the power source of the vehicle. For example, the electrical connection between the traces and the respective electrical connectors at the fourth surface 20b may be made via respective electrically-conductive wraparound coatings that extend across a respective peripheral edge region of the rear glass substrate and that electrically conductively connect to the traces of the perimeter sealing element and to the electrical connectors, or the electrical connection between the traces and the respective electrical connectors at the fourth surface 20b may be made via respective portions of conductive epoxy that are dispensed at and extend across a respective peripheral edge region of the rear glass substrate and that electrically conductively connect to the traces of the perimeter sealing element and to the electrical connectors.

The adhesive strip or tape may have adhesive at one or both sides and may be applied to a perimeter region of the third surface of the rear glass substrate or to a perimeter region of the second surface of the front glass substrate, whereby the other of the front and rear glass substrates is placed at the glass substrate and tape construction and adhered to the adhesive strip or tape to form the laminate construction with an interpane cavity between the glass substrates and bounded by the perimeter sealing element or tape. For example, the adhesive strip may be provided with adhesive on both sides, whereby a backing element or cover film may be removed from one side of the adhesive strip so that the adhesive strip may be adhered to one of the glass substrates, and then the backing element or cover film may be removed from the other side of the adhesive strip so that the adhesive strip may be adhered to the other of the glass substrates to bond the glass substrates together and to establish the interpane cavity between the glass substrates.

In order to accommodate the injection of the electrochromic medium (e.g., a solid polymer matrix or SPM) into the interpane cavity, the tape can be produced with a filling port 32 to work in conjunction with the plugging system. For example, with the front substrate 18 and the rear substrate 20 adhered to one another via the adhesive element 24, the electrochromic medium may be injected into the interpane cavity through a nozzle or other dispensing means disposed at least partially within the filling port 32 at the perimeter edge region of the mirror reflective element between the front substrate 18 and the rear substrate 20.

Optionally, the tape may be continuous (no filling port) to allow filling of the medium through a hole 34 drilled in the rear glass substrate. That is, the hole 34 may extend between the fourth surface 20b and the third surface 20a of the rear substrate 20 so that the electrochromic medium may be injected into the interpane cavity through the nozzle disposed at or at least partially within the hole 34 at the rear surface of the mirror reflective element.

Such a construction offers advantages over known seals, including lower capital investment, lower energy consumption in manufacturing, faster production cycle time, etc. In addition, the use of the tape construction and imbedded electrification traces allows for reduction in the width of the concealing surface, such as a perimeter hiding layer or reflective band coated onto the front glass substrate, or a housing having a bezel element that conceals the perimeter edge region of the reflective element. That is, the tape-based sealing element may have a narrower construction and thus a thinner hiding layer may be used. Optionally, if the tape is formed to have acceptable optical properties, such that the sealing element 24 is hidden or rendered covert from view by the driver viewing the mirror reflective element, the reflective band or bezel element may be partially or entirely eliminated.

The tape-based sealing element thus provides an alternative to the polymeric seals that require long cure periods in the manufacturing process with controlled baking temperatures and time periods, and which also require for curing of epoxies meant for electrochromic electrification. The tape-based sealing element provides for integrated electrification traces and quicker application and finishing times.

Although shown and described as a mirror reflective element for an interior rearview mirror assembly that mounts at an interior portion of the vehicle (e.g., at a windshield or headliner of a vehicle equipped with the mirror assembly) via mounting structure, the mirror reflective element is equally suitable for use in an exterior rearview mirror assembly. For example, the exterior rearview mirror assembly may include a mounting arm having an attaching end that attaches at an exterior portion of the vehicle and a distal end distal from the attaching end. A mirror head is disposed at the distal end of the mounting arm and accommodates the electrochromic mirror reflective element, whereby the mirror reflective element is adjustable to set a rearward view of the driver along the side of the vehicle. Optionally, the mirror reflective element may adjust together and in tandem with the mirror head so that the mirror head may be positionable or adjustable relative to a side of the vehicle to set the rearward view of the driver along the side of the vehicle.

The mirror casing may include a bezel portion that circumscribes a perimeter region of the front surface of the reflective element, or the perimeter region of the front surface of the reflective element may be exposed (such as by utilizing aspects of the mirror reflective elements described in U.S. Pat. Nos. 8,508,831 and/or 8,730,553, and/or U.S. Publication Nos. US-2014-0022390; US-2014-0293169 and/or US-2015-0097955, which are hereby incorporated herein by reference in their entireties).

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

As discussed above, the mirror assembly comprises an electro-optic or electrochromic mirror assembly that includes an electro-optic or electrochromic reflective element. The perimeter edges of the reflective element may be encased or encompassed by the perimeter element or portion of the bezel portion to conceal and contain and envelop the perimeter edges of the substrates and the perimeter seal disposed therebetween. The electrochromic mirror element of the electrochromic mirror assembly may utilize the principles disclosed in commonly assigned U.S. Pat. Nos. 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, which are hereby incorporated herein by reference in their entireties.

Optionally, the reflective element may include an opaque or substantially opaque or hiding perimeter layer or coating or band disposed around a perimeter edge region of the front substrate (such as at a perimeter region of the rear or second surface of the front substrate) to conceal or hide or the perimeter seal from viewing by the driver of the vehicle when the mirror assembly is normally mounted in the vehicle. Such a hiding layer or perimeter band may be reflective or not reflective and may utilize aspects of the perimeter bands and mirror assemblies described in U.S. Pat. Nos. 5,066,112; 7,626,749; 7,274,501; 7,184,190; 7,255,451; 8,508,831 and/or 8,730,553, which are all hereby incorporated herein by reference in their entireties. Optionally, the perimeter band may comprise a chrome/chromium coating or metallic coating and/or may comprise a chrome/chromium or metallic coating that has a reduced reflectance, such as by using an oxidized chrome coating or chromium oxide coating or “black chrome” coating or the like (such as by utilizing aspects of the mirror assemblies described in U.S. Pat. Nos. 7,184,190 and/or 7,255,451, which are hereby incorporated herein by reference in their entireties). Optionally, other opaque or substantially opaque coatings or bands may be implemented.

The interior mirror assembly may comprise a dual-mode interior rearview video mirror that can switch from a traditional reflection mode to a live-video display mode, such as is by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2021-0162926; US-2021-0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety.

The mirror assembly may include a camera or sensor or light of a driver monitoring system and/or head and face direction and position tracking system and/or eye tracking system and/or gesture recognition system. Such head and face direction and/or position tracking systems and/or eye tracking systems and/or gesture recognition systems may utilize aspects of the systems described in U.S. Pat. Nos. 11,582,425; 11,518,401; 10,958,830; 10,065,574; 10,017,114; 9,405,120 and/or 7,914,187, and/or U.S. Publication Nos. US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 18/508,351, filed Nov. 14, 2023 (Attorney Docket DON01 P4996), and/or U.S. patent application Ser. No. 18/535,183, filed Dec. 11, 2023 (Attorney Docket MAG04 P5021), and/or International Publication Nos. WO 2023/220222; WO 2023/034956; WO 2022/241423 and/or WO 2022/187805, which are hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. An electrochromic mirror reflective element sub-assembly for a vehicular rearview mirror assembly, the electrochromic mirror reflective element sub-assembly comprising:
a front substrate having a first surface and a second surface opposite the first surface, wherein a transparent electrically conductive coating is disposed at the second surface of the front substrate;
a rear substrate having a third surface and a fourth surface opposite the third surface, wherein an electrically conductive coating is disposed at the third surface of the rear substrate;
a perimeter sealing element disposed between the second surface and the third surface and bounding an interpane cavity of the electrochromic mirror reflective element sub-assembly between the front substrate and the rear substrate;
wherein the perimeter sealing element comprises an adhesive strip that is adhered to a perimeter region of the second surface of the front substrate and to a perimeter region of the third surface of the rear substrate;
wherein the perimeter sealing element comprises (i) a first electrically conductive trace for electrically connecting to the transparent electrically conductive coating disposed at the second surface of the front substrate and (ii) a second electrically conductive trace for electrically connecting to the electrically conductive coating disposed at the third surface of the rear substrate; and
an electrochromic medium disposed within the interpane cavity, and wherein the electrochromic medium contacts the transparent electrically conductive coating disposed at the second surface of the front substrate and the electrically conductive coating disposed at the third surface of the rear substrate.

2. The electrochromic mirror reflective element sub-assembly of claim 1, wherein the front substrate comprises a front glass substrate, and wherein the rear substrate comprises a rear glass substrate.

3. The electrochromic mirror reflective element sub-assembly of claim 1, wherein the perimeter sealing element is a continuous sealing element around a periphery of the interpane cavity, and wherein the electrochromic medium is filled into the interpane cavity between the front substrate and the rear substrate via a fill hole formed through the rear substrate.

4. The electrochromic mirror reflective element sub-assembly of claim 1, wherein the perimeter sealing element comprises a gap, and wherein the electrochromic medium is filled into the interpane cavity between the front substrate and the rear substrate via the gap.

5. The electrochromic mirror reflective element sub-assembly of claim 1, wherein the electrically conductive coating disposed at the third surface of the rear substrate comprises a mirror reflector.

6. The electrochromic mirror reflective element sub-assembly of claim 1, wherein the electrically conductive coating disposed at the third surface of the rear substrate comprises a transparent electrically conductive coating, and wherein a mirror reflector is disposed at the fourth surface of the rear substrate.

7. The electrochromic mirror reflective element sub-assembly of claim 1, wherein the electrochromic mirror reflective element sub-assembly is for a vehicular interior rearview mirror assembly that is configured for mounting at an interior portion of a vehicle.

8. The electrochromic mirror reflective element sub-assembly of claim 1, wherein the electrochromic mirror reflective element sub-assembly is for a vehicular exterior rearview mirror assembly that is configured for mounting at an exterior portion of a vehicle.

9. The electrochromic mirror reflective element sub-assembly of claim 1, wherein the perimeter sealing element is laser cut based on a shape of the rear substrate prior to being adhesively attached to the perimeter region of the second surface of the front substrate and to the perimeter region of the third surface of the rear substrate.

10. The electrochromic mirror reflective element sub-assembly of claim 1, wherein the perimeter sealing element is die cut based on a shape of the rear substrate prior to being adhesively attached to the perimeter region of the second surface of the front substrate and to the perimeter region of the third surface of the rear substrate.

11. The electrochromic mirror reflective element sub-assembly of claim 1, wherein the first electrically conductive trace is electrically conductively connected to a first electrical connector disposed at the fourth surface of the rear substrate, and wherein the second electrically conductive trace is electrically conductively connected to a second electrical connector disposed at the fourth surface of the rear substrate.

12. The electrochromic mirror reflective element sub-assembly of claim 11, wherein the first and second electrical connectors disposed at the fourth surface of the rear substrate are configured to electrically connect to a power source of a vehicle when the vehicular rearview mirror assembly is mounted at the vehicle.

13. The electrochromic mirror reflective element sub-assembly of claim 12, wherein the first electrically conductive trace is electrically conductively connected to the first electrical connectors via an electrically conductive epoxy disposed at a respective peripheral edge region of the rear substrate.

14. The electrochromic mirror reflective element sub-assembly of claim 12, wherein the second electrically conductive trace is electrically conductively connected to the second electrical connectors via an electrically conductive epoxy disposed at a respective peripheral edge region of the rear substrate.

15. The electrochromic mirror reflective element sub-assembly of claim 12, wherein the first electrically conductive trace is electrically conductively connected to the first electrical connector via an electrically conductive coating that extends across a respective peripheral edge region of the rear substrate.

16. The electrochromic mirror reflective element sub-assembly of claim 12, wherein the second electrically conductive trace is electrically conductively connected to the second electrical connector via an electrically conductive coating that extends across a respective peripheral edge region of the rear substrate.

17. A vehicular interior rearview mirror assembly, the vehicular interior rearview mirror assembly comprising:
a mounting structure configured to attach at an interior portion of a cabin of a vehicle equipped with the vehicular interior rearview mirror assembly;
a mirror head accommodating an electrochromic mirror reflective element;
wherein, with the mounting structure attached at the interior portion of the cabin of the vehicle, the electrochromic mirror reflective element is adjustable by a driver of the vehicle to set a rearward view for the driver;
wherein the electrochromic mirror reflective element comprises a front glass substrate having a first surface and a second surface opposite the first surface, and wherein a transparent electrically conductive coating is disposed at the second surface of the front glass substrate;
wherein the electrochromic mirror reflective element comprises a rear glass substrate having a third surface and a fourth surface opposite the third surface, and wherein an electrically conductive coating is disposed at the third surface of the rear glass substrate;
wherein a perimeter sealing element is disposed between the second surface and the third surface and bounding an interpane cavity of the electrochromic mirror reflective element between the front glass substrate and the rear glass substrate;
wherein the perimeter sealing element comprises an adhesive strip that is adhered to a perimeter region of the second surface of the front glass substrate and to a perimeter region of the third surface of the rear glass substrate;
wherein the perimeter sealing element comprises (i) a first electrically conductive trace for electrically connecting to the transparent electrically conductive coating disposed at the second surface of the front glass substrate and (ii) a second electrically conductive trace for electrically connecting to the electrically conductive coating disposed at the third surface of the rear glass substrate; and
wherein an electrochromic medium is disposed within the interpane cavity, and wherein the electrochromic medium contacts the transparent electrically conductive coating disposed at the second surface of the front glass substrate and the electrically conductive coating disposed at the third surface of the rear glass substrate.

18. The vehicular interior rearview mirror assembly of claim 17, wherein the perimeter sealing element is a continuous sealing element around a periphery of the interpane cavity, and wherein the electrochromic medium is filled into the interpane cavity between the front glass substrate and the rear glass substrate via a fill hole formed through the rear glass substrate.

19. The vehicular interior rearview mirror assembly of claim 17, wherein the perimeter sealing element comprises a gap, and wherein the electrochromic medium is filled into the interpane cavity between the front glass substrate and the rear glass substrate via the gap.

20. The vehicular interior rearview mirror assembly of claim 17, wherein the first electrically conductive trace is electrically conductively connected to a first electrical connector disposed at the fourth surface of the rear glass substrate, and wherein the second electrically conductive trace is electrically conductively connected to a second electrical connector disposed at the fourth surface of the rear glass substrate.

21. The vehicular interior rearview mirror assembly of claim 20, wherein the first electrically conductive trace is electrically conductively connected to the first electrical connectors via one selected from the group consisting of (i) an electrically conductive epoxy disposed at a respective peripheral edge region of the rear glass substrate and (ii) an electrically conductive coating that extends across the respective peripheral edge region of the rear glass substrate.

22. The vehicular interior rearview mirror assembly of claim 20, wherein the second electrically conductive trace is electrically conductively connected to the second electrical connectors via one selected from the group consisting of (i) an electrically conductive epoxy disposed at a respective peripheral edge region of the rear glass substrate and (ii) an electrically conductive coating that extends across the respective peripheral edge region of the rear glass substrate.

23. A vehicular exterior rearview mirror assembly, the vehicular exterior rearview mirror assembly comprising:
a mounting arm comprising (i) an attaching end configured for attachment at an exterior portion of a vehicle equipped with the vehicular exterior rearview mirror assembly and (ii) a distal end that is distal from the attaching end;
a mirror head comprising an electrochromic mirror reflective element, wherein the mirror head is disposed at the distal end of the mounting arm;
wherein, with the mounting arm attached at the exterior portion of the vehicle, the electrochromic mirror reflective element is adjustable to set a rearward view for a driver of the vehicle;
wherein the electrochromic mirror reflective element comprises a front glass substrate having a first surface and a second surface opposite the first surface, and wherein a transparent electrically conductive coating is disposed at the second surface of the front glass substrate;
wherein the electrochromic mirror reflective element comprises a rear glass substrate having a third surface and a fourth surface opposite the third surface, and wherein an electrically conductive coating is disposed at the third surface of the rear glass substrate;
wherein a perimeter sealing element is disposed between the second surface and the third surface and bounding an interpane cavity of the electrochromic mirror reflective element between the front glass substrate and the rear glass substrate;
wherein the perimeter sealing element comprises an adhesive strip that is adhered to a perimeter region of the second surface of the front glass substrate and to a perimeter region of the third surface of the rear glass substrate;
wherein the perimeter sealing element comprises (i) a first electrically conductive trace for electrically connecting to the transparent electrically conductive coating disposed at the second surface of the front glass substrate and (ii) a second electrically conductive trace for electrically connecting to the electrically conductive coating disposed at the third surface of the rear glass substrate; and
wherein an electrochromic medium is disposed within the interpane cavity, and wherein the electrochromic medium contacts the transparent electrically conductive coating disposed at the second surface of the front glass substrate and the electrically conductive coating disposed at the third surface of the rear glass substrate.

24. The vehicular exterior rearview mirror assembly of claim 23, wherein the perimeter sealing element is a continuous sealing element around a periphery of the interpane cavity, and wherein the electrochromic medium is filled into the interpane cavity between the front glass substrate and the rear glass substrate via a fill hole formed through the rear glass substrate.

25. The vehicular exterior rearview mirror assembly of claim 23, wherein the perimeter sealing element comprises a gap, and wherein the electrochromic medium is filled into the interpane cavity between the front glass substrate and the rear glass substrate via the gap.

26. The vehicular exterior rearview mirror assembly of claim 23, wherein the first electrically conductive trace is electrically conductively connected to a first electrical connector disposed at the fourth surface of the rear glass substrate, and wherein the second electrically conductive trace is electrically conductively connected to a second electrical connector disposed at the fourth surface of the rear glass substrate.

27. The vehicular exterior rearview mirror assembly of claim 26, wherein the first electrically conductive trace is electrically conductively connected to the first electrical connectors via one selected from the group consisting of (i) an electrically conductive epoxy disposed at a respective peripheral edge region of the rear glass substrate and (ii) an electrically conductive coating that extends across the respective peripheral edge region of the rear glass substrate.

28. The vehicular exterior rearview mirror assembly of claim 26, wherein the second electrically conductive trace is electrically conductively connected to the second electrical connectors via one selected from the group consisting of (i) an electrically conductive epoxy disposed at a respective peripheral edge region of the rear glass substrate and (ii) an electrically conductive coating that extends across the respective peripheral edge region of the rear glass substrate.
